(19) United States
(12) Patent Application Publication
(10) Pub. No.: US 2025/0242935 A1
(43) Pub. Date: Jul. 31, 2025

(54) METHOD AND SYSTEM FOR ASSISTING WITH THE RESTART OF AT LEAST ONE AIRCRAFT ENGINE

(71) Applicant: Airbus Operations (S.A.S.), Toulouse (FR)

(72) Inventors: Yoan Domecq, Toulouse (FR); Clément Arbona, Blagnac (FR)

(21) Appl. No.: 19/036,347

(22) Filed: Jan. 24, 2025

(30) Foreign Application Priority Data
Jan. 30, 2024 (FR) FR2400903

(51) Int. Cl. B64D 31/09

(52) U.S. Cl. CPC B64D 31/09

(57) ABSTRACT

An assistance system and method for assisting with the restart of at least one engine of an aircraft includes determining that at least one engine of the aircraft has flamed out and controlling an automated descent of the aircraft down to a predefined target altitude below which the altitude of the aircraft is conducive to at least one attempt to restart the at least one stopped engine.

### TECHNICAL FIELD

The disclosure herein relates to a method and a system for automatically assisting with the restart of at least one engine of an aircraft, in the case of a flame out of the latter. In particular, the disclosure herein relates to the implementation of an automatic guidance mode in order to make the aircraft fly under conditions conducive to the restart of the stopped engine or engines.

### BACKGROUND

In a multi-engine aircraft, the unintentional shutdown of one or more engines is generally linked to the flame out of the combustion chamber. This flame out of the engines may have numerous causes, such as for example the lack of fuel, the lack of oxygen at high altitude, a crushed compressor, damage caused by foreign bodies (e.g., exceptional rainfall, debris, birds, volcanic ash, etc.). In particular, the following situations are distinguished: either all the engines are stopped (i.e., total flame out of the engines of the aircraft, which corresponds to a situation here referred to as TEFO, acronym for “total engine flame out”), or only one engine is stopped (such a situation is referred to here as OEI, acronym for “one engine inoperative”).

In the case of a flame out, the engines of the aircraft still keep their capacity to restart. For this purpose, various restart procedures may be executed in order to allow the crew (e.g., one or two pilots) of the aircraft to restart the engine or engines that are stopped.

According to a first restart procedure for restarting the engines, in the first moments following the TEFO or the OEI, an engine control system or FADEC (acronym for “full authority digital engine control”) tries to automatically restart the engine or engines. If the automatic restart of the engine or engines by the FADEC is not successful, then one of the manual procedures for restarting the engine or engines such as described hereinafter needs to be carried out.

An “assisted restart” procedure consists of the use of air extracted from a bleed system of an auxiliary power unit (or APU) for supplying pneumatic power to the stopped engine or engines. The APU is an independent system designed to operate on the ground and in flight. Its main function consists in supplying the energy needed to provide electrical and pneumatic power as a support or in an emergency.

A restart procedure referred to as “windmilling mode” uses the relative wind to supply power to the engines. More specifically, under the effect of the speed of flight, the rotating parts of the stopped engine or engines rotate (i.e., windmill) and it is not then generally necessary to use a starter of the aircraft. The capacity to restart in windmilling mode depends on the altitude and on the speed of the aircraft at the time of the flame out of the engine or engines.

The restart of the engine or engines is easier at low altitudes and at low speeds of flight. Thus, the restart of the engine or engines is only possible when the aircraft descends below 25 000 ft (or 7.62 km). If the conventional air speed (or CAS) of the aircraft is less than 250 kt (or 463 kph), and if the air from the bleed system of the APU can be used, then the assisted restart procedure may be carried out. Conversely, if the conventional speed of the aircraft is high enough (i.e., CAS higher than 250 kt or 463 kph), then the windmilling restart procedure may be carried out. It should be noted that as the torque provided via the windmilling mode is generally higher according to the manual procedure, this manual procedure for restarting the engines is preferred to that of the assisted restart.

In order to be able to carry out one of these engine restart procedures under the best possible conditions, the aircraft must be within a flight envelope suitable for the restart of the engines. In the following, for the sake of simplicity, the flight envelope suitable for the execution of one of the procedures (automatic or manual) for restarting the engines hereinabove is referred to as engine restart flight envelope. The flight envelope is a set of conditions of altitude and of speed of the aircraft, notably conducive to the restart of an engine. In other words, the flight envelope is defined by a particular altitude and speed of the aircraft. Thus, the engine restart flight envelope is the flight envelope within which it is possible to engage the aforementioned procedures (automatic or manual) for restarting the engines.

Thus, the flight envelope suitable for the execution of one of these engine restart procedures corresponds to an altitude lower than or equal to 25 000 ft (i.e. 7.62 km) and a speed of the aircraft in the range between 130 kts (i.e. 240.76 kph) and 340 kts (i.e. 629.68 kph). Accordingly, if the current flight envelope of the aircraft (i.e., at the time of the flame out of one engine or of all the engines) is different from the flight envelope suitable for the execution of one of these engine restart procedures, then the crew will need to guide the aircraft toward this engine restart flight envelope.

Currently, in the case of TEFO, the functions of the automatic flight system (or AFS) are disengaged. In particular, the functions of the auto-pilot (or AP) devices, of the flight director (or FD) and of the auto-thrust (or A/THR) device are disengaged, in order to allow the crew to take over the manual guidance of the aircraft. In particular, the crew may: either perform a manual guidance procedure so as to place the aircraft within the engine restart flight envelope or re-engage one of the devices of the AFS system and perform the descent toward the engine restart flight envelope in a guided manner (e.g., by the flight director FD device). When the crew is composed of two persons, the pilot flying (denoted by the acronym PF) manipulates the flight controls of the aircraft and provides the manual guidance of the latter. The other pilot, called pilot monitoring (denoted by the acronym PM) carries out and follows the procedure for restarting the engines adapted to the situation. Thus, where necessary, in the case of flame out of one or of all the engines, the pilot flying PF guides the aircraft manually (e.g., with or without assistance of the flight director FD device) toward the engine restart flight envelope, whereas the pilot monitoring PM supervises the engine restart procedures.

All of these procedures for restarting the engines and for manual guidance of the aircraft toward the engine restart flight envelope are cumbersome and require at least two persons present in the cockpit in order to share the tasks. Thus, in the case of incapacity of one of the pilots, or when there is only one pilot provided for the flight, all of these procedures are not readily managed.

It is accordingly desirable to overcome this drawback of the prior art.

It is notably desirable to provide a solution which allows the pilot or pilots to be assisted in the execution of the engine restart procedures. In particular, it is desirable to assist the pilot flying PF in the guidance of the aircraft toward the engine restart flight envelope.

### SUMMARY

Here, a system is provided for assisting with the restart of at least one engine of an aircraft. The assistance system comprises electronic circuitry configured for:
determining that at least one engine of the aircraft has flamed out,
controlling an automated descent of the aircraft down to a predefined target altitude below which the altitude of the aircraft is conducive to at least one attempt to restart the at least one stopped engine.

Advantageously, in the case of flame out of one engine or of all the engines of the aircraft, it is possible to assist the crew in the management of the guidance of the aircraft toward the engine restart flight envelope. It is therefore easier for the crew to supervise and to carry out the various engine restart procedures. In other words, it is possible to assist the crew in such a situation by reducing their workload. Alternatively, or additionally, it is also possible to assist the crew in the supervision and the execution of the procedures for restarting the engine or engines even if the crew only consists of a single pilot (for example when only one pilot is provided on the flight, or when one of the two pilots is incapacitated), or else when the lone pilot is incapable of flying the aircraft.

According to one embodiment, the system for assisting with the restart of at least one aircraft engine furthermore comprises electronic circuitry configured for controlling the automated descent of the aircraft while at the same time applying a reduction of a conventional speed of the aircraft down to a predefined target conventional speed below which the conventional speed of the aircraft is conducive to a restart of the at least one stopped engine.

According to one embodiment, the system for assisting with the restart of at least one aircraft engine furthermore comprises electronic circuitry configured for generating a message for execution of at least one procedure for restarting the at least one stopped engine with a view to carrying out the at least one attempt to restart the at least one stopped engine when the target altitude and/or the target conventional speed is reached by the aircraft.

According to one embodiment, the system for assisting with the restart of at least one aircraft engine furthermore comprises electronic circuitry configured for controlling the automated descent of the aircraft based on at least one parameter from amongst:
the number of stopped engines,
the state of activation of an auto-pilot device of the aircraft,
the state of activation of a flight director device of the aircraft,
the state of a current guidance mode of the aircraft,
the number of pilot(s) present in the cockpit of the aircraft,
the number of pilot(s) capable of flying the aircraft present in the cockpit of the aircraft.

According to one embodiment, the system for assisting with the restart of at least one aircraft engine is implemented in a guidance controller device of the aircraft.

Here, a method is also provided for assisting with the restart of at least one engine of an aircraft. The method is implemented by an assistance system in the form of electronic circuitry. The method comprising:
determining that at least one engine of the aircraft has flamed out,
controlling an automated descent of the aircraft down to a predefined target altitude below which the altitude of the aircraft is conducive to at least one attempt to restart the at least one stopped engine.

According to one embodiment, the method for assisting with the restart of at least one engine of an aircraft furthermore comprises controlling the automated descent of the aircraft while at the same time applying a reduction of a conventional speed of the aircraft down to a predefined target conventional speed below which the conventional speed of the aircraft is conducive to a restart of the at least one stopped engine.

According to one embodiment, the method for assisting with the restart of at least one aircraft engine furthermore comprises generating a message for execution of at least one procedure for restarting the at least one stopped engine with a view to carrying out the at least one attempt to restart the at least one stopped engine when the target altitude and/or the target conventional speed is reached by the aircraft.

According to one embodiment, the method for assisting with the restart of at least one aircraft engine furthermore comprises controlling the automated descent of the aircraft based on at least one parameter from amongst:
the number of stopped engines,
the state of activation of an auto-pilot device of the aircraft,
the state of activation of a flight director device of the aircraft,
the state of a current guidance mode of the aircraft,
the number of pilot(s) present in the cockpit of the aircraft,
the number of pilot(s) capable of piloting the aircraft present in the cockpit of the aircraft.

Here, an aircraft is provided comprising a system for assisting with the restart of at least one aircraft engine such as described hereinabove according to one embodiment.

A computer program product is also provided, comprising instructions leading to the execution, by a processor, of the method described hereinabove according to any one of its embodiments, when the instructions are executed by the processor. A storage medium is also provided storing such instructions.

### BRIEF DESCRIPTION OF THE DRAWINGS

The aforementioned features of the disclosure herein, together with others, will become more clearly apparent upon reading the following description of at least one example embodiment, the description being presented in relation with the appended drawings, amongst which:

FIG. 1 illustrates schematically, as a side view, an aircraft equipped with a system for assisting with the restart of the engines of an aircraft, according to one embodiment;

FIG. 2 illustrates schematically the system for assisting with the restart of at least one of the engines of an aircraft, according to one embodiment;

FIG. 3 illustrates schematically one example of a hardware platform allowing the assistance system according to one embodiment to be implemented in the form of electronic circuitry;

FIG. 4 illustrates schematically the steps of a method for assisting with the restart of the engine or engines of the aircraft executed by the engine restart assistance system, according to one embodiment.

### DETAILED DESCRIPTION

The general principle of the following disclosure relates to the execution of an automatic guidance function of an aircraft and of an associated automatic descent mode of the aircraft, in the case of a flame out of at least one of its engines. It is thus possible to assist a crew of the aircraft to automatically guide the latter toward a flight envelope conducive to a restart of the stopped engine or engines. The workload of the crew is accordingly reduced, notably when there is only one pilot (e.g., the pilot flying PF) present in the cockpit of the aircraft, or when the latter is incapable of piloting the aircraft.

FIG. 1 illustrates schematically, as a side view, an aircraft 100 equipped with a system for assisting with the restart of the engines of the aircraft 101, according to one embodiment. In the following, for simplicity, this system for assisting with the restart of the engines of the aircraft 101 is referred to as “assistance system 101”.

According to the embodiment in FIG. 1, the assistance system 101 is an onboard electronic equipment in the aircraft 100. For example, the assistance system 101 forms part of an electronic circuitry of the avionics of the aircraft 100. Preferably, the assistance system 101 is integrated into a guidance controller device of the aircraft 100, for example a guidance computer of the aircraft of the FGS (for “Flight Guidance System”) type.

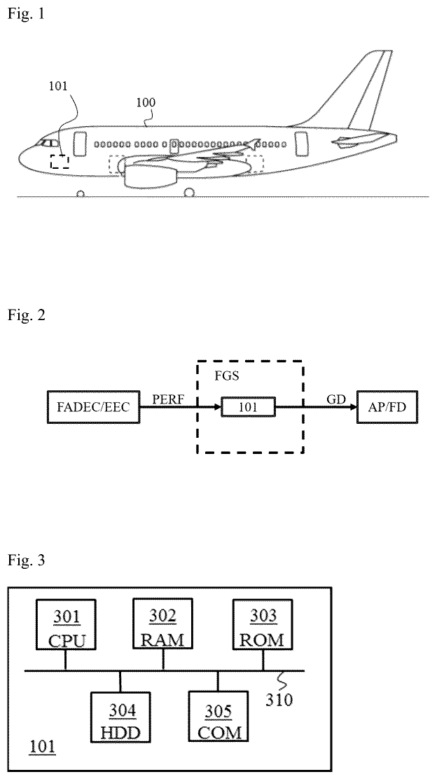

The assistance system 101 is schematically and globally illustrated in FIG. 2, according to one embodiment. According to this embodiment, the assistance system 101 is integrated into a guidance controller device FGS of the aircraft 100.

The assistance system 101 is configured for receiving, for each engine of the aircraft 100, information representative of performance characteristics PERF of the engines. This information on the performance characteristics PERF of the engines is transmitted by a system for controlling the engines of the aircraft 100, such as for example a FADEC, and/or engine controller computer EEC (for “Electronic Engine Controller”). The FADEC and the EEC are systems controlling all the aspects of performance of the engines of the aircraft 100. In the following, these systems (i.e., FADEC and EEC), or any other systems for controlling the performance of the engines of the aircraft 100 are referred to as engine performance control systems. The FADEC also controls the start-up and the restart of the engines.

This information on the performance characteristics PERF of the engines notably comprises information on various indicators of engine performance such as for example the indicators N1, N2, N3 . . . indications on the operating state of the EEC of each engine (e.g., nominal or fault state), indications on the position of the control lever of each engine (e.g., lever in position “ON”).

The assistance system 101 is furthermore configured for transmitting guidance information GD for the guidance of the aircraft 100 to an automatic pilot device AP and to a flight director device FD of the aircraft 100. This guidance information GD notably comprises information on a lateral and/or longitudinal guidance to be followed to an altitude and to a speed to be reached, and more generally any information allowing the aircraft 100 to be guided toward a particular point or according to a particular flight path.

The assistance system 101 is also configured for receiving various pieces of information coming from other avionic systems of the aircraft 100 (not shown in FIG. 2). This information is for example information relating to the operational state (armed, engaged, disengaged, etc.) of certain guidance functions, and potentially of their associated guidance mode, which are not managed by the assistance system 101, information relating to the altitude of the aircraft, the speed of the aircraft, the number of pilot(s) present in the cockpit, etc.

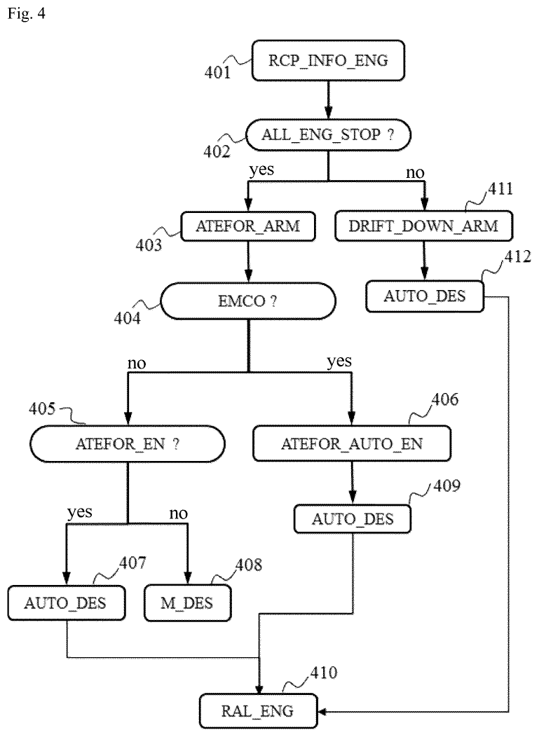

FIG. 3 illustrates schematically one example of hardware platform allowing the assistance system 101 to be implemented in the form of electronic circuitry, according to one embodiment.

The hardware platform comprises, connected via a communications bus 310, a processor or CPU (for “Central Processing Unit”) 301; a volatile memory RAM (for “Random-Access Memory”) 302; a non-volatile memory 303, for example of the ROM (for “Read Only Memory”) or EEPROM (for “Electrically-Erasable Programmable ROM”) type, such as a Flash memory; a storage unit, such as a hard disk HDD (for “Hard Disk Drive”) 304, or a storage medium reader, such as an SD (for “Secure Digital”) card reader; and an interface manager COM 305.

The interface management COM 305 allows the assistance system 101 to interact with other avionic systems of the aircraft 100 such as for example systems for monitoring the performance characteristics of the engines (FADEC, EEC, etc.), flight systems of the aircraft 100 (automatic pilot device AP, flight director device FD, etc.), display systems of a human-machine interface in the cockpit of the aircraft 100 (for example: CDC for “Cockpit Display System”, PFD for “Primary Flight Display”, FMA for “Flight Mode Annunciator”).

The processor 301 is designed to executing instructions loaded into the volatile memory 302 from the non-volatile memory 303, from an external memory, from a storage medium (such as an SD card) or from a communications network. When the hardware platform is powered up, the processor 301 is designed to read instructions from the volatile memory 302 and executing them. These instructions form a computer program causing the implementation, by the processor 301, of all or part of the steps or methods or, more broadly, operational sequences of the aircraft described in the present description.

All or part of the steps, methods and operations described here may thus be implemented in software form by execution of a set of instructions by a programmable machine, for example a processor of the DSP (for “Digital Signal Processor”) type or a microcontroller, or may be implemented in hardware form by a machine or a dedicated electronic component (or “chip”) or a set of dedicated electronic components (or “chipset”), for example an FPGA (for “Field Programmable Gate Array”) or ASIC (for “Application Specific Integrated Circuit”) component. Generally speaking, the assistance system 101 comprises electronic circuitry designed and configured for implementing all or part of the operations, methods and steps described here.

In conjunction with FIG. 4, the steps of a method for assisting with the restart of at least one engine of the aircraft 100 are presented in the form of a diagram, according to one embodiment. All or part of this method for assisting with the restart of at least one engine of the aircraft 100 is implemented by the assistance system 101 described hereinabove.

During a step 401, denoted RCP_INFO_ENG, the assistance system 101 receives, for each engine of the aircraft 100, from one or more systems for monitoring performance characteristics of the engines (e.g., FADEC or EEC), information on the performances of the engines PERF.

It should be noted that an engine is considered as being in an “operating state” when all the following conditions are met:
the main lever corresponding to this engine is in the operating position (i.e., the lever is set to the “ON” position),
the EEC associated with this engine (i.e., EEC controlling the engine) is not defective,
the engine is declared as “in an operating state” by the EIF (for “Engine Interface Function”) or the EEC, when the latter has measured that the real performance indicator N3 is higher than 50%.

The indicator N3 is a cockpit gauge which indicates the speed of rotation of the high pressure (i.e., high speed) coil of an aircraft engine. The speed of this coil is called N3. The indicator N3 is generally calibrated in percentage of rotations/minute on the basis of a speed of rotation defined by the manufacturer of the engine and corresponding to 100%.

Thus, for each engine, information on performance characteristics PERF of the engines notably comprises an indication relating to the position of the main lever of the engine, the state of the EEC of the engine and the indicator N3.

During a step 402, denoted ALL_ENG_STOP, using the information on performance characteristics of the engines PERF for each engine, the assistance system 101 determines an operating state of each engine of the aircraft 100. The assistance system 101 subsequently determines whether all the engines (indication “yes” in FIG. 4) or a single engine (indication “no” in FIG. 4) of the aircraft 100 are/is stopped. The assistance system 101 determines that one engine is stopped, or “is not working”, when the information on performance characteristics PERF of this engine indicates that at least one of the conditions hereinabove is not met for this engine.

Following the determination of the number of stopped engines, the assistance system 101 controls an automated descent of the aircraft 100. Here, “controlling an automated descent of the aircraft 100” is understood to mean all of the successive steps leading to the arming, then the engagement of the automatic descent mode, denoted AUTO DES, and up to its disengagement. In other words, the control of the automated descent of the aircraft 100 corresponds to the steps 403 to 407 and 409 and 411 to 412.

During a step 403, denoted ATEFOR_ARM, the assistance system 101 has previously determined that all the engines are stopped (step 402, with result “yes”). It then arms a guidance function of the aircraft 100 called “for automatic re-establishment after total flame out of the engines” or guidance function ATEFOR (for “Automatic Total Engine Flame Out Recovery”). It is understood here that a guidance mode or function called “armed” corresponds to a state that will be activated if and when the aircraft 100 passes a target (e.g., target altitude, target speed, etc.).

This guidance function ATEFOR is limited to the configuration of the aircraft 100 referred to as “CLEAN”, in other words a configuration according to which no landing gear, nor any flap, nor also any device for increasing the drag or wing lift is deployed, etc.

The aim of this guidance function ATEFOR is to decrease the workload of the crew when all the engines have accidentally shut down. In particular, the guidance function ATEFOR allows the automatic guidance of the aircraft 100 toward the engine restart flight envelope. The crew can therefore concentrate on the execution of the various engine restart procedures available.

The engagement of the guidance function ATEFOR by the assistance system 101 is conditioned by the operational state of the aircraft 100. It is understood here that a guidance mode or function referred to as “engaged” corresponds to a state that the automatic pilot device AP keeps active. Furthermore, “operational state” is understood here to mean the number of pilots present in the cockpit at each phase of flight of the aircraft 100 (e.g., takeoff, cruising, landing, etc.). In other words, the engagement of the guidance function ATEFOR depends on the fact that the aircraft 100 is in an operational state called “out of EMCO” or in an operational state called “in EMCO” (for “Extended Minimum Crew Operation”). According to the “out of EMCO” operational state, or dual-control operations, there are at least two pilots present in the cockpit, namely the pilot flying or PF and the pilot monitoring or PM. In contrast, during EMCO, or single control operations, there is only one pilot in the cockpit, in other words the pilot flying or PF. This is for example the case during a phase of flight of the aircraft 100 referred to as “cruising”.

The engagement of the function ATEFOR also depends on the status of the automatic pilot AP (i.e., engaged or disengaged) at the time of the flame out of all the engines.

Thus, during a step 404, the assistance system 101 obtains information on the operational state of the aircraft 100, in other words information indicating whether the aircraft 100 is “in EMCO” operations (indication “yes” in FIG. 4) or “out of EMCO” operations (indication “no” in FIG. 4).

According to one embodiment, this information on the operational state of the aircraft 100 is obtained from a human-machine interface of the CDS. The CDS (or “Cockpit Display System”) allows the crew via its human-machine interface to activate or to disable the function “in EMCO”. In other words, it is the crew that choses between the “in EMCO” operational state by activating this function or the “out of EMCO” operational state by disabling the “in EMCO” function via an interaction with the human-machine interface of the CDS.

If the aircraft 100 is in an “out of EMCO” operational state (step 404, with result “no”), then there are at least two pilots in the cockpit. During a step 405, denoted ATEFOR_EN, the assistance system 101 therefore obtains information relating to the current status of the automatic pilot AP device (i.e., at the time of the detection of the TEFO). This information on the status of the auto-pilot device AP indicates whether the auto-pilot device AP is engaged or whether it is disengaged, respectively. Depending on this information on the status of the auto-pilot device AP, the assistance system 101 determines that the auto-pilot device AP is engaged or disengaged.

In one particular embodiment, the assistance system 101 furthermore obtains one or more pieces of information representative of the current status of the flight director device FD (i.e., at the time of the detection of the TEFO). This information on the status of the flight director device FD indicates whether the flight director device FD is engaged or whether it is disengaged, respectively. Depending on this information relating to the status of the flight director device FD, the assistance system 101 determines that the flight director device FD is engaged or disengaged.

If the auto-pilot device AP is already engaged at the time of the flame out of all the engines, then the assistance system 101 keeps the auto-pilot device AP engaged. The assistance system 101 then engages the guidance function ATEFOR.

If the auto-pilot device AP is disengaged at the time of the flame out of all the engines, then the assistance system 101 does not automatically engage the auto-pilot device AP in order to avoid any undesirable automatic control of the guidance of the aircraft 100. Thus, in one embodiment, in the framework of “out of EMCO” operations, when the auto-pilot device AP is disengaged at the time of the detection of the TEFO, during the step 405 ATEFOR_EN, the assistance system 101 interrogates the crew (notably the pilot flying PF) with regard to the engagement or otherwise of the auto-pilot device AP in order to engage the guidance function ATEFOR. In one example, the assistance system 101 transmits a message intended for the crew to a human-machine interface in the cockpit of the aircraft 100. This message indicates that the guidance function ATEFOR is armed and ready to be engaged if the crew desires it. In order to engage the guidance function ATEFOR, the crew then has to engage the auto-pilot device AP.

In the case where the pilot flying PF wants to manually undertake the descent of the aircraft 100 toward the engine restart flight envelope (step 408, denoted M_DES), then he/she does not engage the auto-pilot device AP and the guidance function ATEFOR is not engaged (step 405 ATEFOR_EN, result “no”). Thus, conventionally, the guidance of the aircraft 100 toward the engine restart flight envelope is manually carried out by the pilot flying PF, whereas the pilot monitoring PM supervises and implements the engine restart procedures.

On the other hand, if the pilot flying PF wants to undertake entirely automatically a descent of the aircraft 100 toward the engine restart flight envelope (step 407 denoted AUTO_DES), then he/she engages the auto-pilot device AP (for example by pushing a button provided on the human-machine interface in the cockpit of the aircraft 100). The assistance system 101 then receives a command to engage the auto-pilot device AP, for example via the human-machine interface in the cockpit of the aircraft 100. The assistance system 101 then engages the guidance function ATEFOR (step 405 ATEFOR_EN, result “yes”). Consequently, when all the engines are stopped, during the normal operations referred to as “out of EMCO”, the guidance function ATEFOR is only engaged if the auto-pilot device AP is already engaged.

In one embodiment, during the step 405 ATEFOR_EN, when the function ATEFOR is armed, the assistance system 101 automatically engages the flight director FD, irrespective of its status at the time of the flame out of all the engines.

Thus, when the function ATEFOR is not engaged (i.e., when the auto-pilot device AP is not engaged) it is possible for the pilot flying PF to carry out the descent of the aircraft 100 manually toward the engine restart flight envelope (step 408, denoted M_DES) with the aid of the flight director FD.

On the other hand, when the function ATEFOR is engaged (i.e., when the auto-pilot device AP is already engaged or when the pilot flying PF engages the auto-pilot device), the auto-pilot device AP then follows the guidance instructions of the flight director device FD (step 407 denoted AUTO_DES).

If the aircraft 100 is in an “in EMCO” operational state (step 404, result “yes”), then there is only one pilot in the cockpit (i.e., the pilot flying PF). In this situation, during the step 406, denoted ATEFOR_AUTO_EN, the assistance system 101 automatically engages the auto-pilot device AP, even if it were not previously engaged. The engagement of the guidance function ATEFOR by the assistance system 101 is then automatic, since the auto-pilot device AP is automatically engaged.

In one particular embodiment, during the step 406 ATEFOR_AUTO_EN, the assistance system 101 furthermore automatically engages the flight director device FD, even if it were not previously engaged. The auto-pilot device AP then follows the guidance instructions of the flight director device FD.

During the “out of EMCO” operations, the guidance function ATEFOR may be disengaged at any time by disconnecting the auto-pilot device AP. For example, the pilot flying PF wishes to take over the controls and manually guide the aircraft 100 toward the engine restart flight envelope. Alternatively, the guidance function ATEFOR may be disengaged by changing the guidance order into “Selected Mode”. In other words, when the pilot flying switches the guidance into “selected mode” and changes the flight objectives of flight parameters such as: speed, flight path, altitude, etc., the guidance function ATEFOR is disengaged.

During the “in EMCO” operations, the guidance function ATEFOR allows:
when the pilot flying PF is present and conscious in the cockpit: the workload of the pilot flying PF to be reduced, since, without the guidance function ATEFOR, he/she is assumed to perform the guidance of the aircraft 100 toward the engine restart flight envelope and to supervise one or more procedures for restarting the engine at the same time,
when the pilot flying PF is in a critical physiological state: the “capacity for survival” (or longevity) of the aircraft 100 in the 5 minutes following the flame out of all the engines of the aircraft 100 to be improved,
when the pilot flying PF is present in the cockpit, but he/she is stricken with incapacity: the “capacity for survival” of the aircraft 100 in the 40 minutes following the flame out of all the engines to be improved.

Thus, in the case of a flame out of all the engines, the assistance system 101 can modify the status of engagement or of disengagement of the auto-pilot device AP and, as the case may be, of the flight director device FD as a function of the various operational scenarios described hereinabove. The assistance system 101 may therefore engage the guidance function ATEFOR in order to reduce the workload of the crew relating to the guidance of the aircraft 100 toward the engine restart flight envelope. Indeed, during “out of EMCO” or “in EMCO” operations, during the engagement of the guidance function ATEFOR, it is the auto-pilot device AP which automatically guides the aircraft 100 toward the engine restart flight envelope. The guidance function ATEFOR is therefore an advantageous automatic guidance function of the aircraft 100. The crew, and in particular the pilot flying PF, is therefore spared from having to accomplish the task of guiding the aircraft 100 manually down to the engine restart flight envelope.

When the guidance function ATEFOR is engaged, the consequences are the following:
the air brakes of the aircraft 100 are automatically retracted if they have been previously deployed,
the managed speed (i.e., speed objective given by the FMS or “flight management system”) is inhibited for the whole duration of the engagement of the guidance function ATEFOR, and a new speed objective, called target speed, is calculated by the assistance system 101 and is displayed on the PFD (“Primary Flight Display”),
an automatic descent mode denoted AUTO DES described hereinafter is armed. This automatic descent mode AUTO DES is available in the “out of EMCO” operations or in the “in EMCO” operations. It should be noted that this automatic descent mode AUTO DES is armed as soon as the flame out of all the engines is detected (i.e., TEFO detection).

The engagement of the guidance function ATEFOR (step 405, result “yes” and step 406) allows the assistance system 101, where necessary, to engage the automatic descent mode AUTO DES. Thus, during the steps 407 and 409, in order to be able to automatically guide the aircraft 100 toward the engine restart flight envelope, the assistance system 101 sends out guidance information GD on the aircraft 100 (e.g., information on a lateral guidance, a longitudinal guidance, target altitude and target speed, etc.) to the auto-pilot device AP.

### Lateral Guidance

Prior to engaging the automatic descent mode AUTO DES, the assistance system 101 transmits information relating to a lateral guidance to the auto-pilot device AP allowing the current path of the aircraft 100 to be modified taking into account a predefined angle of inclination. This information on lateral guidance depends notably on an activation state of a current guidance mode of the aircraft 100. This information on lateral guidance therefore allows the auto-pilot device AP to perform the following procedures:
if a guidance mode called “Navigation” or NAV is engaged (i.e., guidance mode according to which the aircraft 100 follows a flight path defined in a flightplan and following predefined flight paths) during the flame out of all the engines, then the auto-pilot device AP comes out of this guidance mode NAV and guides the aircraft 100 to perform a lateral step according to the predefined angle of inclination. This lateral step allows the aircraft 100 to be moved off the current path. An offset with respect to the current path of the aircraft 100 is defined in order to allow the aircraft 100 to be positioned parallel to the axis of its current path while at the same time remaining within the air corridors with no risk of interference with the air traffic. For this purpose, the auto-pilot device AP makes a change from the guidance mode NAV to a guidance mode referred to as “Tracking” or TRK. This guidance mode allows the auto-pilot device AP to follow or to keep to a route, rather than a predefined flight path,
if the guidance mode TRK is engaged, then the auto-pilot device AP follows this guidance mode and keeps the route or the current flight path angle of the aircraft 100.

In order to limit the loss of energy during the lateral step maneuver, a limitation of 15° for maximum inclination angle (Phi) of the wings of the aircraft 100 is implemented. This limitation is cancelled in the case of actions of the crew along the lateral axis stopping the lateral step or if the guidance function ATEFOR is no longer active or if the automatic descent mode AUTO DES is disengaged.

### Longitudinal Guidance: Engagement of the Automatic Descent Mode AUTO DES

As soon as the assistance system 101 determines that all the engines are stopped, then the automatic descent mode AUTO DES is armed. When the guidance function ATEFOR is engaged, an engagement of the automatic descent mode AUTO DES is subsequently authorized as soon as the conditions allow it, in other words:
when the conventional speed of the aircraft CAS (V_{CAS}) reached in a current longitudinal guidance mode (e.g., a guidance mode for maintaining the altitude such as the guidance mode ALT for “Altitude”) is lower than a target speed of the guidance function ATEFOR, with an additional margin of 5 kts (i.e., 9.26 kph). The automatic descent mode AUTO DES is then engaged directly after arming, or
when the conventional speed of the aircraft V_{CAS} reached in a current longitudinal guidance mode is higher than a target speed of the guidance function ATEFOR, with an additional margin of 5 kts (i.e., 9.26 kph), and when the conventional speed of the aircraft V_{CAS} becomes lower than the target speed of the guidance function ATEFOR, with an additional margin of 5 kts (i.e., 9.26 kph), or
when the aircraft 100 is in a climb, the guidance function ATEFOR first of all allows the auto-pilot device AP to perform a levelling off, then, the automatic descent mode AUTO DES is engaged, when the conventional speed of the aircraft V_{CAS} is lower than a target speed of the guidance function ATEFOR, with an additional margin of 5 kts (i.e., 9.26 kph), or
when the aircraft 100 is in a descent with the speed V_{CAS} higher than the target speed of the guidance function ATEFOR, with an additional margin of 5 kts (i.e., 9.26 kph), and when the assisted restart procedure is requested, the guidance function ATEFOR first of all allows the auto-pilot device AP to perform a levelling off. The automatic descent mode AUTO DES is engaged, when the conventional speed of the aircraft CAS (V_{CAS}) is lower than a target speed of the guidance function ATEFOR, with an additional margin of 5 kts (i.e., 9.26 kph), or
when the aircraft 100 is in a descent (e.g., in Managed mode, in a descending longitudinal guidance mode such as the mode DES for “Descent”) with the speed V_{CAS} higher than the target speed of the guidance function ATEFOR, with an additional margin of 5 kts (i.e., 9.26 kph), and when the assisted restart procedure is not requested, then the automatic descent mode AUTO DES is engaged directly after arming.

The condition for disengagement of the automatic descent mode AUTO DES is the engagement by the crew of another longitudinal guidance mode (e.g., engagement in the “selected” mode of the descent guidance mode OP DES for “Open Descent”).

In the case of disengagement of the automatic descent mode AUTO DES, the target speed becomes the current speed in the mode known as “selected”.

During the engagement of the automatic descent mode AUTO DES, the buttons of the Flight Control Unit (denoted by the acronym FCU) for altitude ALT, for approach APPR and for localization LOC are inhibited in the context of “in EMCO” operations (i.e., one pilot in the cockpit) with the auto-pilot device AP engaged. Indeed, in an “in EMCO” context, it is desirable for the guidance function ATEFOR to be engaged. In order to pre-empt any accidental actions which could prevent the guidance function ATEFOR from being engaged, these altitude ALT, approach APPR and localization LOC buttons are inhibited.

Outside of the “EMCO” operations (i.e., at least two pilots in the cockpit), the use of these buttons remains possible, together with the engagement or the arming of the corresponding guidance mode.

Independently of the inhibition of the buttons of the FCU, the approach guidance modes cannot be engaged when the automatic descent mode AUTO DES is engaged, because the priority is given to restarting the engines.

### Target Altitude

When the automatic descent mode AUTO DES is engaged, a new predefined altitude target (i.e., target altitude) is synchronized on the FCU at 1000 ft (i.e., 304.8 m), for example. The automatic descent mode AUTO DES therefore allows the aircraft 100 to be put into a descent toward this target altitude.

### Target Speed

When the guidance function ATEFOR is engaged, the assistance system 101 calculates a predefined target speed to be reached when the automatic descent mode AUTO DES is engaged.

In one embodiment, when the crew has not yet decided which manual procedure to perform for restarting the engines (i.e., assisted or windmilling restart), the target speed is calculated on the maximum UD (i.e., lift-to-drag ratio) speed of the aircraft 100. During the engagement of the automatic descent mode AUTO DES, in the case of unavailability of the maximum L/D speed, the target speed is a default speed, for example 250 kts (i.e., 463 kph).

In another embodiment, when the crew has decided which procedure for restarting the engines (i.e., assisted or windmilling restart) to carry out, the target speed, and as a consequence also the vertical speed, is adapted according to the chosen restart strategy.

When the automatic descent mode AUTO DES is disengaged, the target speed is updated so as to correspond to the current maximum UD speed in “Selected” mode (i.e., the value displayed on the FCU).

In one embodiment, on the flight mode annunciator or FMA, the automatic descent mode AUTO DES is announced like any other guidance mode with auto-pilot device AP or flight director device FD with the generation of a white frame accompanied by an audible sound (e.g., a triple click).

In one embodiment, when the automatic descent mode AUTO DES is engaged, the terms “AUTO DES” are displayed on the FMA in cyan for the arming mode and “AUTO DES” must be displayed on the FMA in green with a normal white frame for the engaged mode.

The automatic descent mode AUTO DES therefore allows the auto-pilot device AP to guide the aircraft 100 automatically toward the engine restart flight envelope. Thus, once the aircraft 100 reaches this engine restart flight envelope, the various engine restart procedures previously described may be executed.

In one embodiment, during the step 410, denoted RAL_ENG, the assistance system 101 sends out a message for execution of a procedure for restarting the engines with a view to carrying out at least one attempt to restart the stopped engines. In other words, once the aircraft reaches the engine restart flight envelope, the assistance system 101 transmits a message for execution of a procedure for restarting the engines either to a system controlling the performance characteristics of the engines (e.g., FADEC) for the execution of the procedure to restart the engines automatically, or to the human-machine interface in the cockpit of the aircraft 100 for interrogating the crew as to the manual procedure for restarting the engines to be executed.

In one embodiment, when the guidance function ATEFOR is engaged, the assistance system 101 transmits this message for execution of a procedure for restarting the engines to the systems for controlling performance characteristics of the engines, such as for example the FADEC, in order to restart the engines. Thus, in the case of flame out of all the engines, the FADEC automatically attempts successive restarts until at least one engine is restarted. It is thus possible to relieve the crew of the function for monitoring the automatic restart by the FADEC. The function ATEFOR therefore relies on improvements in the procedure for automatically restarting the engines, notably in order to assist the crew during “EMCO” operations with physiological impairment of the pilot or in the incapacity of piloting.

In one embodiment, in parallel with the execution of the procedure for automatically restarting the engines by the FADEC, the assistance system 101 furthermore transmits this message for execution of a procedure for restarting the engines to the human-machine interface in the cockpit of the aircraft 100 for interrogating the crew as to the manual procedure for restarting the engines to be executed. The crew (i.e., one or two pilots) may execute one of the manual procedures for restarting the engines adapted to the situation in a conventional manner.

If the aircraft 100 recovers at least one engine following the execution of one or the other, or of several engine restart procedures, then:
the function of the automatic thrust device A/THR is engaged with a maximum continuous thrust (or MCT), even if the thrust lever is on “IDLE”,
as regards the lateral guidance, the guidance mode TRK remains engaged and the route or the guidance of the flight path defined during the execution of the automatic descent mode AUTO DES is conserved,
with regard to the longitudinal guidance:
(i) if the target altitude of the automatic descent mode AUTO DES is higher than an altitude of the OEI (for “one engine inoperative”) ceiling, then the automatic descent mode AUTO DES remains engaged with a new target altitude corresponding to the altitude of the OEI ceiling to be reached. The guidance function ATEFOR is disengaged, but a “Drift Down” guidance function (described hereinafter) assumes the responsibility for guidance of the aircraft 100 with the automatic descent mode AUTO DES which remains engaged,
(ii) if the target altitude of the automatic descent mode AUTO DES is lower than the altitude of the OEI ceiling, then the automatic descent mode AUTO DES is disengaged and the guidance mode VS/FPA (navigation mode which allows the vertical speed or the angle of attack of the flight path to be selected) is engaged in order to perform a levelling off of the aircraft 100. The guidance function ATEFOR is disengaged.

The altitude of the OEI ceiling corresponds to the altitude to which, following the failure of an engine above the altitude of the OEI ceiling, an airplane will descend and will level off, while at the same time using the maximum power/thrust available on the engine in service and while maintaining the intended OEI speed.

A new target speed is calculated by the assistance system 101 as current maximum L/D speed.

In one embodiment, on the FMA, in the section dedicated to the vertical modes, “AUTO DES” is followed by the displaying of the engagement of the new guidance mode at the exit from the automatic descent mode AUTO DES. The displaying of the new guidance mode may be carried out manually or following an engine restart event.

The “Drift Down” guidance function (or involuntary loss of altitude) is executed when a multi-engine aircraft suffers a failure of one of the engines in flight. When an engine is lost, the aircraft 100 cannot maintain its flight level by virtue of the thrust created by the remaining engine or engines and hence must descend. The “Drift Down” guidance function thus denotes all of the descent procedures and strategies for the aircraft 100 executed when such a problem occurs.

During the step 402 ALL_ENG_STOP, the assistance system 101 determines, based on the performance information for the engines PERF, that only one of the engines of the aircraft 100 is no longer operating (denoted “no” in FIG. 4). As a consequence, during the step 411, denoted DRIFT_DOWN_ARM, the assistance system 101 arms, then engages the “Drift Down” guidance function, if the current altitude at the time of the flame out of one engine is located above the altitude of the OEI ceiling.

In order to be able to guide the aircraft 100 toward the engine restart flight envelope, the assistance system 101 arms the automatic descent mode AUTO DES via the engagement of the “Drift Down” guidance function. Thus, the automatic descent mode AUTO DES provides assistance to the crew in carrying out the guidance of the aircraft 100 toward the engine restart flight envelope in the case of loss of a single engine.

The guidance of the aircraft 100 via the automatic descent mode AUTO DES is similar to that carried out when the automatic descent mode AUTO DES is used with the engagement of the guidance function ATEFOR.

However, in one embodiment, when the “Drift Down” guidance function is engaged, the automatic descent mode AUTO DES is armed if the altitude at which the engine has flamed out is higher than the altitude of the OEI ceiling. Indeed, below the altitude of the OEI ceiling, no automatic guidance is implemented using the automatic descent mode AUTO DES with one engine still operating.

### Lateral Guidance

In the same way as for the guidance function ATEFOR, the assistance system 101 transmits to the auto-pilot device AP information on the lateral guidance of the aircraft 100.

However, in contrast to the guidance function ATEFOR, there is no limitation in the angle of inclination for the lateral step prior to the engagement of the descent mode AUTO DES in the context of the “Drift Down” guidance function.

### Longitudinal Guidance: Engagement of the Automatic Descent Mode AUTO DES

The longitudinal guidance is similar to the function ATEFOR, with the same transitions for engagement of the automatic descent mode AUTO DES, depending on the speed and on the climbing or descent phase. Thus, where necessary, the assistance system 101 engages the automatic descent mode AUTO DES during the step 412.

### Target Altitude

If the current altitude of the aircraft 100 (i.e., at the time of the flame out of the engine) is higher than the altitude of the OEI ceiling, then the target altitude to be reached is the altitude of the OEI ceiling during the engagement of the automatic descent mode AUTO DES.

As for the guidance function ATEFOR with the automatic descent mode AUTO DES, during the step 410, denoted RAL_ENG, the assistance system 101 sends out a message for execution of a procedure for restarting the engines with a view to carrying out at least one attempt to restart the stopped engines. In other words, once the aircraft reaches the engine restart flight envelope, the assistance system 101 transmits a message for execution of a procedure for restarting the engines either to a system for controlling the performance characteristics of the engines (e.g., FADEC) for the execution of the procedure for automatically restarting the engines, or to the human-machine interface in the cockpit of the aircraft 100 for interrogating the crew on which manual procedure for restarting the engines to execute.

If the last shutdown engine is restarted before reaching the altitude of the OEI ceiling, then the assistance system 101 engages the guidance mode VS/FPA in order to perform a levelling off of the aircraft 100. In other words, if all the engines are operating after execution of the “Drift Down” function and of the automatic descent mode AUTO DES, then there is no longer any need for the aircraft 100 to descend, and a levelling off may be carried out.

According to one embodiment, if an emergency descent procedure is already engaged, together with its associated guidance mode (e.g., emergency descent mode EMER DES) when an engine is lost, the “Drift Down” guidance function is not engaged and hence the automatic descent mode AUTO DES is not armed. Indeed, since one engine is still operating and has enough power, the priority remains assigned to the emergency descent for the survival of the crew.

According to one embodiment, the function of the automatic thrust device A/THR is automatically adjusted upon activation of the “Drift Down” guidance function, if it is not already engaged.

In one particular embodiment, when the ATEFOR or “Drift Down” guidance functions are engaged, the TCAS (for “Traffic collision avoidance system”) switches into “Traffic Advisory Only” mode (i.e., the TCAS will not provide avoidance instructions).

In one embodiment, when the descent mode AUTO DES is engaged in the case of flame out of all the engines, the descent mode AUTO DES has priority over the emergency descent mode EMER DES, in order to prioritize the energy saving of the aircraft 100 with respect to the rate of descent. However, as previously described, in the case of engagement of the “Drift Down” guidance function while the emergency descent mode EMER DES is already activated, the emergency descent EMER DES remains activated and the automatic descent mode AUTO DES is not armed (with one remaining engine and an emergency descent already activated, recovering oxygen and saving the crew has a higher priority).

In one particular embodiment, the automatic descent mode AUTO DES may also be used in the case of detection of a loss of the two air bleed systems of an engine (referred to as “double bleed loss” denoted by the abbreviation DBL). The consequences of a double bleed loss of an engine go from the obligation to perform an about turn in flight to the depressurization of the aircraft cabin followed by a diversion. In the case of a DBL, there is an attempt to reset the two air bleed systems of the engine. It should be noted that this reset is only authorized if there is no air leak. If this reset is not authorized (e.g., in the case of a leak) or is not successful, a warning is generated and the crew must make a descent. The arming, then, where appropriate, the engagement of the automatic descent mode AUTO DES provides assistance to the crew in guiding the aircraft 100 toward the suitable flight envelope avoiding the depressurization of the cabin. It is thus possible to reduce the workload of the pilot or pilots (for example, in order to assist a pilot flying during “in EMCO” operations).

In this particular embodiment, the assistance system 101 determines that there is a double bleed loss of an engine of the aircraft 100. The assistance system 101 then arms the automatic descent mode AUTO DES. Where necessary, for example in the case of a failure to reset the two air bleed systems or if it is not authorized, the assistance system 101 engages the automatic descent mode AUTO DES.

The automatic descent mode AUTO DES may be engaged so as to carry out a first descent down to 24 000 ft (i.e. around 7.32 km), for example because this is situated within the flight envelope within which it is possible to use the air bleed from the APU to replace the double bleed loss of the engine and to avoid the depressurization of the cabin.

The automatic descent mode AUTO DES may be engaged so as to carry out a second descent from 24 000 ft to 10 000 ft (i.e. from around 7.32 km to 3.048 km), if necessary, when it is not possible to use the air bleed from the APU in order to avoid the depressurization of the cabin.

Alternatively, if it is acceptable to avoid this second descent by reason of the low probability of not being able to use the air bleed from the APU in the case of absence of the two air bleed systems of an engine, and if a depressurization of the cabin is reached after the first automatic descent to 24 000 ft (i.e. around 7.32 km) (for example, since it is finally not possible to use the air bleed from the APU), then the automatic emergency descent (already known) is engaged.

While at least one example embodiment of the invention(s) is disclosed herein, it should be understood that modifications, substitutions, and alternatives may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An assistance system for assisting with a restart of at least one stopped engine of an aircraft, the assistance system comprising electronic circuitry configured for:
determining that at least one stopped engine of the aircraft has flamed out;
controlling an automated descent of the aircraft down to a predefined target altitude below which the altitude of the aircraft is conducive to at least one attempt to restart the at least one stopped engine; and
generating a message for execution of at least one procedure for restarting the at least one stopped engine with a view to carrying out the at least one attempt to restart the at least one stopped engine when the target altitude and/or a target conventional speed is reached by the aircraft.

2. The assistance system of claim 1, comprising electronic circuitry configured for controlling the automated descent of the aircraft while at a same time applying a reduction of a conventional speed of the aircraft down to a predefined target conventional speed below which the conventional speed of the aircraft is conducive to a restart of the at least one stopped engine.

3. The assistance system of claim 1, comprising electronic circuitry configured for controlling the automated descent of the aircraft based on at least one parameter from amongst:
a number of stopped engines;
a state of activation of an auto-pilot device of the aircraft;
a state of activation of a flight director device of the aircraft;
a state of a current guidance mode of the aircraft;
a number of pilot(s) present in a cockpit of the aircraft; and/or
a number of pilot(s) capable of piloting the aircraft present in the cockpit of the aircraft.

4. The assistance system of claim 1, wherein the assistance system is implemented in a guidance controller device of the aircraft.

5. A method for assisting with a restart of at least one engine of an aircraft, the method being implemented by an assistance system comprising electronic circuitry, the method comprising:
determining that at least one stopped engine of the aircraft has flamed out;
controlling an automated descent of the aircraft down to a predefined target altitude below which the altitude of the aircraft is conducive to at least one attempt to restart the at least one stopped engine; and
generating a message for execution of at least one procedure for restarting the at least one stopped engine with a view to carrying out the at least one attempt to restart the at least one stopped engine when the target altitude and/or a target conventional speed is reached by the aircraft.

6. The method of claim 5, comprising controlling the automated descent of the aircraft while at a same time applying a reduction of a conventional speed of the aircraft down to a predefined target conventional speed below which the conventional speed of the aircraft is conducive to a restart of the at least one stopped engine.

7. The method of claim 5, comprising controlling the automated descent of the aircraft based on at least one parameter from amongst:
a number of stopped engines;
a state of activation of an auto-pilot device of the aircraft;
a state of activation of a flight director device of the aircraft;
a state of a current guidance mode of the aircraft;
a number of pilot(s) present in a cockpit of the aircraft; and/or
a number of pilot(s) capable of piloting the aircraft present in the cockpit of the aircraft.

8. An aircraft comprising the assistance system of claim 1.

9. A computer program product, comprising instructions leading to execution, by a processor, of the method of claim 5, when the instructions are executed by the processor.

10. A storage medium, storing a computer program comprising instructions leading to execution, by a processor, of the method of claim 5, when the instructions are read and executed by the processor.
